(19) United States
(12) Patent Application Publication
(10) Pub. No.: US 2011/0230306 A1
(43) Pub. Date: Sep. 22, 2011

(54) VARIATOR

(76) Inventors: Robert Andrew Oliver, Leyland (GB); Adrian Lee, Samlesbury (GB)

(21) Appl. No.: 12/991,342

(22) PCT Filed: May 7, 2009
(86) PCT No.: PCT/US2009/043205

§ 371 Date: May 10, 2011

(30) Foreign Application Priority Data
May 7, 2008 (GB) 0808231.5

(51) Int. Cl. F16H 15/38

(52) U.S. Cl. 476/40

(57) ABSTRACT

A variator (10) has a race formed from an input disc (12) and an output disc (14) and a plurality of rollers (22) located between the input and output discs, for transmitting drive therebetween. Either the input disc (12) and output disc (14) or the rollers (22), but not both, has a sintered powdered metal rolling surface.

This application claims priority to Great Britain Application No. 0808231.5 filed on May 7, 2008, the entire disclosure of which is specifically incorporated herein by reference in its entirety without disclaimer.

The present invention relates to variators and in particular to variators of the toroidal race rolling traction type.

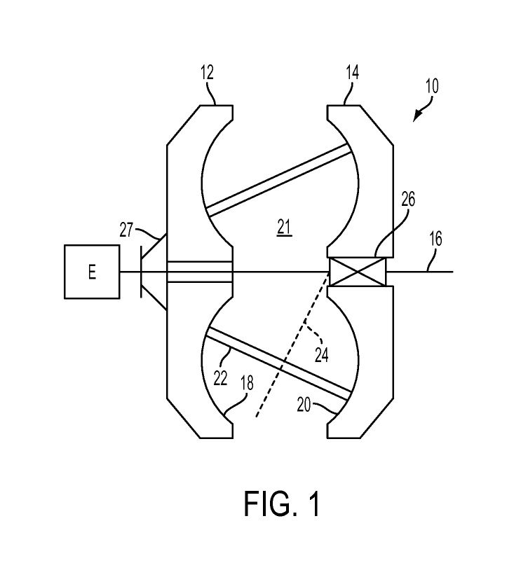

FIG. 1 is a schematic representation of a known variator of the toroidal race, rolling traction type. The general construction of such variators is well known to the skilled person and is described in patents and patent applications held by Torotrak (Development) Limited, including WO2006/084905A1, which is incorporated by reference. Other disclosures are available at www.torotrak.com.

The variator 10 has a pair of variator races 12, 14 mounted for rotation about a common axis defined by a shaft 16. Both races are semi-toroidally recessed as seen at 18 and 20 so that together they define a generally toroidal cavity 21 containing a set of rollers 22. Each roller 22 is mounted for rotation about its own axis 24 and each runs upon the recessed faces 18, 20 of both variator races 12, 14 to transfer drive between them.

Variator race 12 is coupled to the shaft 16 through splines, so that it rotates along with the shaft, and is driven by a rotary powered source such as an engine E which is itself operatively connected to the shaft. Variator race 14 is mounted on a bearing 26 co-axial with the shaft 16 and so is able to rotate independently of it and is coupled to downstream gearing.

In the case of a motor vehicle transmission, this gearing is typically of the epicyclic type and leads to the driven vehicle wheels. Suitable epicyclic gear arrangements are well known in the art. PCT/EP2006/050860 provides one example and is incorporated by reference. The splined mounting of the variator race 12 allows it to move somewhat along the shaft and a spring 27, formed in this embodiment as a Bellvelle washer, urges that race towards the other race to provide the end load. The mountings of the rollers allow them to undergo a tilting motion to change the angle between the roller axis 24 and the shaft 16, changing the variator ratio in the manner very well known in the art.

The rollers and races may be in direct mechanical contact, with drive being transmitted from one to the other through friction at the contact. Other rollers and races may be separated by a thin film of fluid (“variator fluid”). The variator fluid is typically jetted on to the rolling parts and is thus drawn into the region between.

There is a limit to the traction coefficient that can be sustained. If the required traction force becomes excessive in relation to the normal contact force, the result is an unacceptable degree of slippage at the rolling contact, which can result in damage to the variator. The limiting coefficient of traction—at which slippage becomes unacceptable—may depend upon several factors, including, for example, the nature of the surfaces of the rolling parts and the elastohydrodynamic properties of the variator fluid, where present. The high value of the limiting coefficient of traction is desirable because it allows for a reduction in the end load. High end loads can reduce the efficiency of the variator and reduce the effective life of the component parts, especially the races and rollers.

The rollers and races of the variator can cyclically suffer high Hertzian contact pressure. Also, significant heat can be dissipated, creating potentially high temperatures. There may also be large tangential shear forces at their surface. These factors can lead to failure of the rollers and races, as explained in a paper entitled “Developing the Durability of a Dual-Cavity Full Toroidal IVT variator” (Adrian Lee, Jonathan Paul Newall: Torotrak (Development) Limited, Yoshihiro Ono, Teruo Hoshino: Koyo Seiko Co., Limited, SAE 2002 World Congress and Exhibition, March 2002, Detroit: Session: “Transmission and Driveline Systems Symposium” (Part A)—IVT/CVT; Document No. 2002-01-0587, Book No. SP-1655) (referred to as “Durability Paper”).

The Durability Paper describes a prior study of the factors affecting the fatigue life of the variator rollers and races. The rolling parts tested were wrought bearing steel with surfaces that were either ground or lapped. The paper explains that some of these parts underwent rolling contact fatigue, exhibited in two failure modes:

1. Surface distress—“failure of rolling elements by the formation of glazed areas, following by asperity scale microcracks which lead to asperity scale micro-spall craters”; and

2. Spalling—“failure by the formation of macroscopic craters in the contact surface as a result of fatigue crack propagation in the Hertzian stress field” (the words in quotation marks are taken directly from the paper.

The perceived solution to the problems identified in the durability paper was to make the rolling parts of the variator as smooth as commercially possible, in order to resist surface distress. The Durability Paper contained proposed alloys and surface treatments intended to provide compressive residual stress at the roller surface to resist surface initiated cracking

An alternative, and counter-intuitive, solution is disclosed in a co-pending International patent application based on U.S. Ser. No. 11/626,809, the contents of which are incorporated herein by reference. The solution proposed therein is to form the races and the rollers of the variator from pressed, sintered powdered metal. Surprisingly, the variator components did not fail during testing. It is believed that the powdered metal components experienced micro-pitting instead of spalling and, as a result, the parts did not fail. It is also believed that propagation of surface initiated cracks, which would have led to spalling, was limited or eliminated, resulting from the powdered metal morphology. Small particles were lost from the component surface, but the larger cracks which would cause spalling did not develop. It is believed that the micro-pitting renews the running surface of the components to a certain extent to help sustain a level of surface roughness to improve the traction coefficient.

The use of powdered metal variator components is also attractive from a cost point of view, since, depending upon the circumstances, it is often possible to form the components in a single manufacturing operation.

However, it has been found that, while it is possible to form the variator races in a single operation using powdered metal technology, the same cannot normally be said for the rollers. In particular, it has been found necessary in practice to machine and/or heat treat the periphery of rollers produced using powdered metal technology, in order to produce the necessary crowned profile. The result is that the cost of the roller produced using powdered metal technology is comparable with that of a roller formed from wrought steel, as in the prior art.

### SUMMARY OF THE INVENTION

In accordance with the present invention, a variator comprises a race and a plurality of rollers engageable with the race, wherein either the race or the plurality of rollers, but not both, comprises a powdered metal rolling surface.

Surprisingly, it has been found that by having the rolling surface of only one of the race and the rollers formed from powdered metal, the component which is not formed from powdered metal does not fail, notwithstanding the fact that its surface becomes worn.

In a preferred embodiment, the race comprises a sintered powdered metal rolling surface. More preferably, the race is formed entirely from sintered powdered metal.

The roller may comprise a rolling surface of solid metal. More preferably, the roller is formed entirely from solid metal.

In another embodiment, the rollers comprise a sintered powdered metal rolling surface. More preferably, the rollers are formed entirely from sintered powdered metal.

The race may comprise a rolling surface of solid metal. More preferably, the race is formed entirely from solid metal.

By way of example only, a specific embodiment of the present invention will now be described, with reference to the accompanying drawings, in which:

FIG. 1 is a schematic representation of a toroidal race, rolling traction type variator, viewed in a sectional plane containing the axis of the variator, as referred to previously;

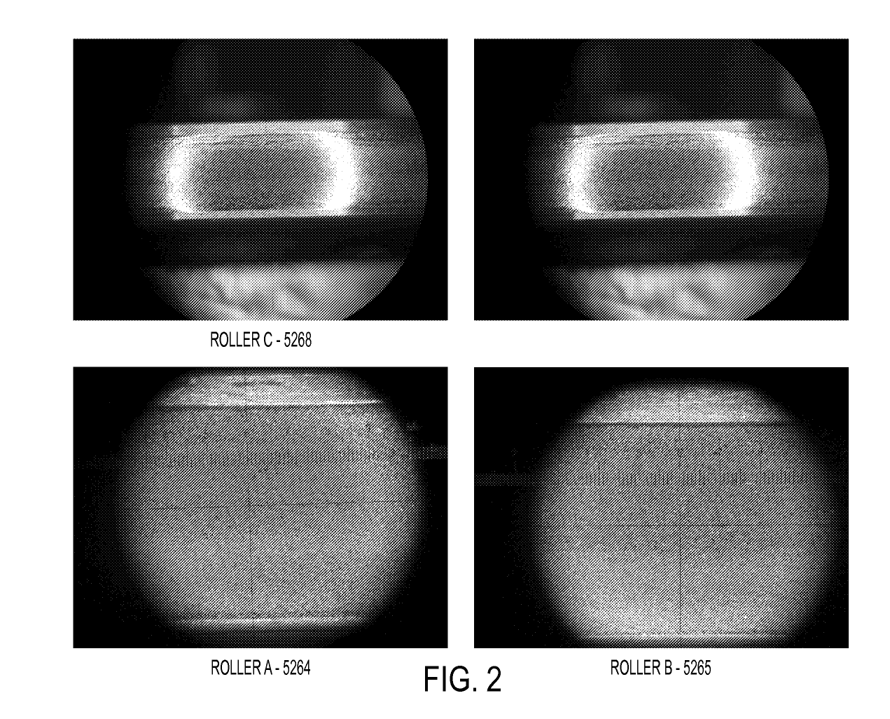

FIGS. 2a to 2d are photographs of the edges of the rollers of an embodiment of variator in accordance with the present invention, after testing;

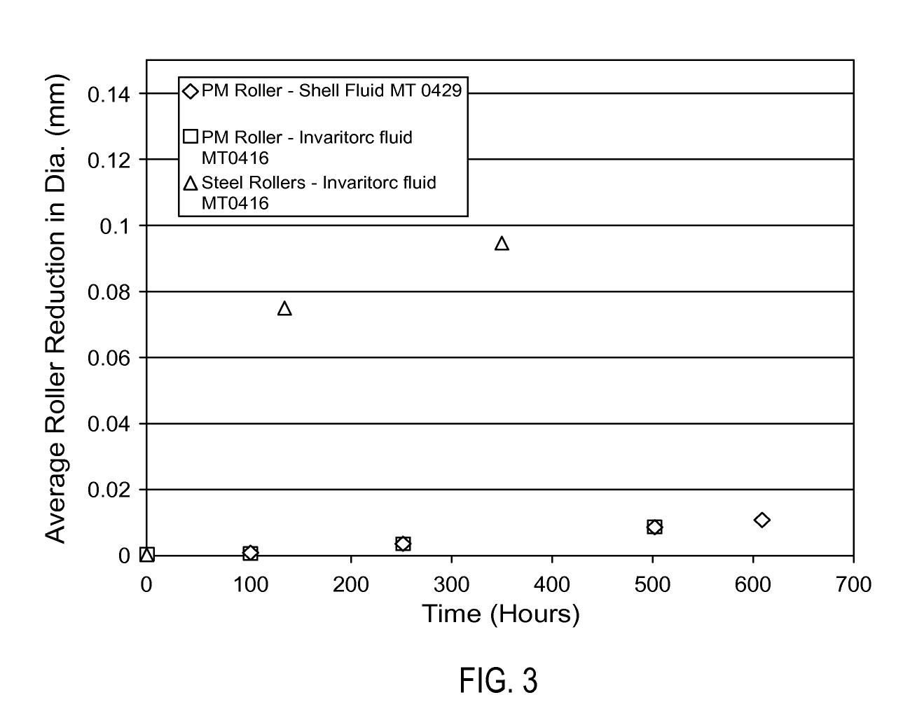

FIG. 3 is a graph showing the rate of wear of the rollers in the variator in accordance with the present invention; and

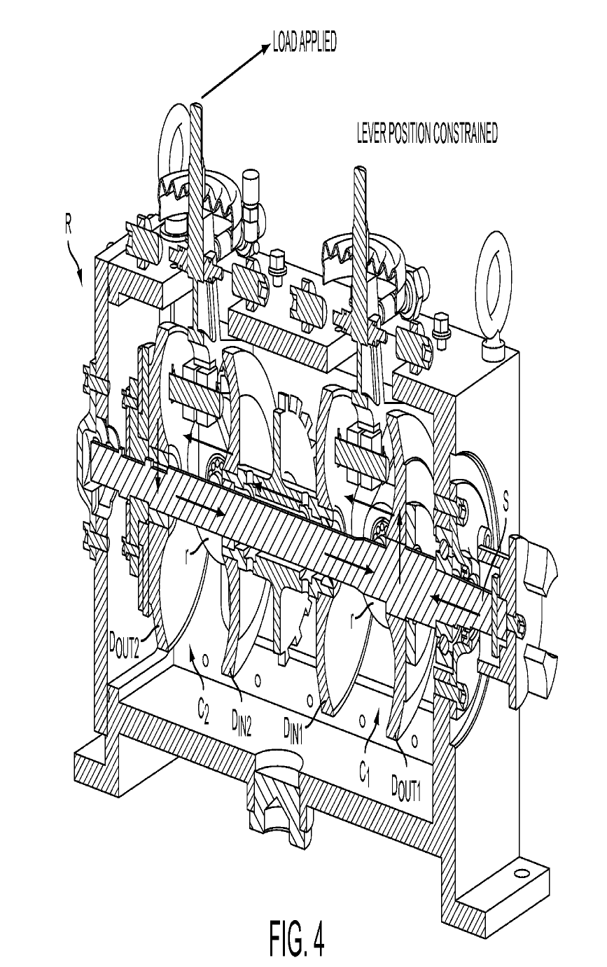

FIG. 4 is a perspective view, partly cut away, of a test rig used for testing the components of the variator of the present invention.

The variator in question is the variator illustrated in FIG. 1 and referred to previously.

The variator races were produced by powdered metal compaction. In particular, powdered metal was placed into compaction tooling conforming to the desired shape of the races. The powdered metal used for manufacturing the discs is the same as that used in the International patent application based on U.S. Ser. No. 11/626,809 namely a low alloy steel, formed using powdered metallurgy from either 0.3% carbon chromium (C—Cr) steel or 0.6% C—Cr steel. The powder in the compaction tooling is subjected to high velocity compaction to create a green compacted component. The part is then sintered by High Velocity Re-strike.

The powdered metal parts are then removed from the compaction tooling. Depending on the use to which the parts are to be put, they may not require any further treatment or machining However, further treatment, for example (heat treatment) and/or machining may take place, if appropriate. The discs have a density of between 7.1 to 7.6 grams per cubic centimetre and a hardness of between 54 and 62 HRc.

The rollers were not made from powdered metal but instead were made from a bar of solid EN 31 through hardened bearing steel, having the following chemical composition:

Carbon (c)—0.9-1.2%

Silicon (Si)—0.1-0.35%

Manganese (Mn)—0.3-0.75%

Phosphorous (P)—0.05% maximum

Sulphur (S)—0.05% maximum

Chromium (Cr)—1.00 to 1.60%

The steel rollers were machined into shape from a bar of the material and then heat treated to achieve a hardness of from 61 to 63 HRc.

The races and rollers were then assembled in a variator configuration and were tested on a test rig R of the type shown in FIG. 4. The testing involved mounting the module on a test rig where it is connected to an electrical motor which drives the module. Power is applied to the module shaft S which is physically connected to the two outer discs D_{OUT1}, D_{OUT2} of each cavity C₁, C₂.

In one cavity C₁ the lever position is held in a suitable fixed position which sets the test ratio. Power passes from the outer disc D_{OUT1} through the rollers r to the inner disc D_{INT1} which is physically connected to the other inner disc D_{IN2} of the second cavity C₂. The lever of this second cavity C₂ has a force/load applied to it this via a cable (not shown) attached to a hanging mass. This force is reacted in the module to raise torque. Thus the module recirculates torque within itself by effectively running one cavity against the other. A Belville washer provides the constant endload force to clamp the two cavities together.

Load cells attached to each lever to enable the measurement of traction coefficient (lever force divided by Belville force/2). The module is also used to measure durability (rolling contact fatigue life) and wear by running at fixed speed, endload, ratio and torque for a given time.

Not surprisingly, the discs, which were formed from powdered metal, did not fail during testing. As for the co-pending International patent application based on U.S. Ser. No. 11/626,809, it is believed that the powdered metal races/discs experienced micro-pitting instead of spalling and, as a result, did not fail. It is also believed that propagation of surface initiated cracks which would have lead to spalling is limited or eliminated resulting from the powdered metal morphology.

Most surprisingly, however, it was found that the rollers formed from “solid” (i.e. non-powdered metal) steel did not suffer catastrophic failure. Instead, as can be seen from FIGS. 2a to 2d, the periphery of each of the rollers showed signs of wear. This was confirmed by measurements. As can be seen in FIG. 3, the rollers experienced considerably greater wear as compared, for example, with the wear of rollers formed from powdered metal.

Explanations of the reasons for the non-powdered metal component performance are not intended to limit the scope of the invention by reference to any particular theory. However, it is thought that the roller formed from non-powdered metal engages the relatively rough surface of the powdered-metal discs, which causes the periphery of the rollers to wear. This is supported by the graph of FIG. 3, which clearly shows a reduction in the diameter of the rollers as the test progresses (see the triangular data points on the graph). This is in contrast to the results of tests for comparable rollers formed from powdered metal (the square and the diamonds on the graph) which show a much smaller reduction in roller diameter).

It is believed that, as a consequence, the solid roller experienced micro-pitting instead of spalling and, as a result, the rollers did not fail. Small particles were lost from the surface of the roller as it wore, but larger cracks which might cause spalling did not develop.

The traction test described above suggests that specialised synthetic traction fluids are not necessary to maintain acceptable performance. Consequently, the present invention may allow the use of less expensive/more economical traction fluid.

Although the invention has been described both with reference to the variator races being formed from powdered metal and the rollers being formed from non-powdered metal, it would be possible for this to be interchanged, namely with the rollers being formed from powdered metal and the races being formed from solid metal. However, since the races can be formed more successfully from powdered metal, it is likely that the rollers would be formed from non-powdered metal since, as explained previously, problems have been encountered in manufacturing rollers from powdered metal.

Moreover, although the embodiments described have one set of components (the race or the rollers) entirely made from sintered powdered metal, it would be sufficient for only the rolling surface to be made from sintered powdered metal. Similarly, it may be sufficient for the component not having a sintered powdered metal rolling surface for only the surface not to be made from sintered powdered metal.

1. A variator comprising a race having an input disc and an output disc and a plurality of rollers for transmitting drive between the input and the output disc, wherein either the race or the plurality of rollers, but not both, comprise a sintered powdered metal rolling surface.

2. A variator as claimed in claim 1, wherein the race comprises a sintered powdered metal rolling surface.

3. A variator as claimed in claim 2, wherein the race is formed entirely from sintered powdered metal.

4. A variator as claimed in claim 2, wherein the roller comprises a rolling surface of solid metal.

5. A variator as claimed in claim 4, wherein the roller is formed entirely from solid metal.

6. A variator as claimed in claim 1, wherein the rollers comprise a sintered powdered metal rolling surface.

7. A variator as claimed in claim 6, wherein the rollers are formed entirely from sintered powdered metal.

8. A variator as claimed in claim 6, wherein the race comprises a rolling surface of solid metal.

9. A variator as claimed in claim 8, wherein the race is formed entirely from metal.
